(19) United States
(12) Patent Application Publication
(10) Pub. No.: US 2015/0205840 A1
(43) Pub. Date: Jul. 23, 2015

(54) Dynamic Data Analytics in Multi-Dimensional Environments

(71) Applicant: Crytek GmbH, Frankfurt/Main (DE)

(72) Inventors: Faruk Yerli, Frankfurt/Main (DE); Alex Taube, Oberursel (DE); Benjamin Peters, Frankfurt/Main (DE)

(21) Appl. No.: 14/158,655

(22) Filed: Jan. 17, 2014

(51) Int. Cl. G06F 17/30; G06F 3/0484

(52) U.S. Cl. CPC G06F 17/30554; G06F 3/04842

(57) ABSTRACT

A system and a method for dynamic data analytics are provided. The system comprises a proxy component including an interface, said proxy component configured to send, via the interface, a request for data to one or more data sources and to receive, via the interface, at least one data set from the one or more data sources, an input interface configured to receive user input, a processing component coupled to the proxy component and the input interface, said processing component configured to receive the at least one data set from the proxy component and, responsive to the user input, to process the at least one data set and to render the processed at least one data set into rendered data, and an output interface configured to provide the rendered data.

### FIELD

The present disclosure relates to a system and a method for dynamic data analytics, which may enable dynamic analysis of data in multi-dimensional environments, such as three-dimensional (3D) environments.

### BACKGROUND

Analysis of data typically refers to tasks where complex data cannot be directly understood and has to be analyzed in order to arrive at informative conclusions on the content and meaning of the data.

Local approaches typically utilize visualization computers that read and visualize local data using various forms of diagrams, such as bar charts, flowcharts, scatter plots, density maps, and the like. However, these approaches typically read the data once from a local storage and display the results in a static manner, usually in two dimensions or in pseudo-3D. With an increasing complexity of the data, the insight into the data, meaning the possible intelligence gained from the data, is becoming confusing and unclear. For example, due to the nature of the static visualization, a viewer of the data may miss some details that may, for example, be difficult to see or even hidden in the finally rendered image.

### SUMMARY

The present disclosure is directed to various illustrative embodiments including a system and a method for dynamic data analytics. Various described embodiments enable dynamic data analysis of large amounts of complex data providing meaningful insight into the data.

According to one aspect of the present disclosure, a system for dynamic data analytics is provided, which comprises a proxy component, an input interface, a processing component coupled to the proxy component and the input interface, and an output interface. Said proxy component includes an interface and is configured to send, via the interface, a request for data to one or more data sources and to receive, via the interface, at least one data set from the one or more data sources. The input interface is configured to receive user input. The processing component is configured to receive the at least one data set from the proxy component and, responsive to the user input, to process the at least one data set and render the processed at least one data set into rendered data. The output interface is configured to provide the rendered data.

The system may retrieve even large and complex data on demand from a variety of data sources and render the retrieved data for display in an abstracted multi-dimensional environment, such as three-dimensional (3D) or four-dimensional animated environments. The data visualization is responsive to user input and can be interactively adapted to current user needs in order to enable a clear analysis of the underlying coarse structure of the data, as well as a detailed analysis of individual details and features represented by the data. For example, the data may be related to key performance indicators (KPIs), which can be variably displayed and put into different contexts. The system also enables dynamic rendering of data sets, for example, from different viewing perspectives, such that users may access a different insight on the data.

The proxy component and the processing component can be realized as computing devices including computer-readable memory with instructions, wherein the instructions, when executed on the respective computing device, cause the computing device to exhibit the described functionality. For example, the processing component can be embodied as a computing device, which may include a memory including instructions to configure the computing device to receive the at least one data set from the proxy component and, responsive to the user input, to process the at least one data set and to render the processed at least one data set into rendered data.

As used herein, the term interface relates to a software layer or dedicated hardware, which defines structure and functionality for communication between two hardware or software entities. An interface may be defined as software, hardware, firmware, or a combination thereof and may be implemented as or represent a functional module of a computing device or a respective component. For example, the interface of the proxy component may be implemented as a software layer of the proxy component or embodied in an interfacing hardware of the proxy component that specifies the structure and type of messages to be exchanged between the proxy component and the one or more data sources to enable sending of requests for data and receiving data sets from various data sources. Similarly, the input interface may define respective structure and functionality for receiving user input data and the output interface may define respective structure and functionality for providing the rendered output data.

The system for dynamic data analytics may use the proxy component to dispatch a request for data, which may include a specification of the required data and/or at least one data source. For example, the data sources may be provided by several data providers. The data may be related to experimental results, results of physical and/or mathematical simulations, or other data reflecting data values of real and/or abstract entities, including business and administrative data.

Based on the indications in the request, the request may be forwarded to the indicated data source. The data source may receive the request, query its data, and return at least one data set matching the indications in the request. The request may, for example, specify an identification of the data, as well as further parameters and conditions that are to be met, such as a time range, an indication of a real and/or virtual entity, and other requirements that are to be met by the data. The data source may identify those data sets matching the request and return the matching data sets, if any, or return an empty set if no data matches the request. If multiple data sources are queried, the request may be sent to all data sources in parallel or may be sequentially sent to a first source and, if no results can be found, to a second data source, and so on until data matching the request is identified or the last data source is reached. The second and further data sources may be data sources on a next organizational level or data sources including data with another level of detail.

The retrieved data sets are received by the proxy component and passed to the processing component, which uses the user input to adapt the processing of the data sets. For example, the user input may indicate that one or more of the data sets are to be selected, filtered, adjusted, expanded, aggregated, or processed in a similar way. The user input may also define filtering criteria or indicate a particular type of presentation for the data sets. The user input may also affect the rendering of the processed data sets in order to generate rendered output data.

The term rendered data, as used throughout this description, refers to data intended for presentation in any suitable modality, such as audio data, image/video data, haptic data, force feedback data, and others as well as combinations thereof. Rendered data may be provided to a suitable output device of a matching modality, for example, using dedicated hardware. For example, video data may be supplied to a display device via a graphics unit that receives the video data and generates respective control signals to control the display device. Similarly, audio data can be provided to speakers or another audio output device via an audio unit resulting in an acoustic presentation of the rendered data. Rendered data may also include signals, which may be directly provided to the display device, or may include intermediate results, which may also be further processed by the output device or associated hardware in order to generate the final representation. For example, the rendered data may include a definition of geometric primitives, which are supplied to a graphics or rendering engine in order to generate the data and signals to control a display device.

The retrieval of data sets from various data sources and rendering of the data sets responsive to individual user input by dedicated components provide a highly flexible and dynamic analysis of large and complex data sets, which can be customized to individual user requirements and allows for meaningful insights into the structure of the data.

According to one embodiment, the at least one data set is associated with at least one graphic element arranged in a scene graph. A scene graph, as used throughout this description, is a general data structure that arranges representations of entities in a graphical scene. The scene graph may include a collection of nodes associated with the representations of the entities and arranged as a directed graph or tree, wherein each node may have children nodes and a parent node. Typically, nodes without children nodes are called leaf nodes and nodes having one or more children nodes are referred to as group nodes. Leaf nodes may reference objects, sprites, sounds, lights, or anything that could be considered as rendered. Typically, an operation performed on a parent node automatically propagates to its children nodes and eventually to the leaf nodes. Each node of the scene graph may include further parameters, such as a transformation matrix, which are applied during processing of the node. For example, the transformation matrix may define a local transformation of the respective node with respect to the parent node.

The graphic elements may include one or more geometric primitives or shapes, such as spheres, cylinders, cubes or boxes, toroids, pyramids, triangular meshes, point clouds, and others. The type of geometric primitive may be directly determined by the type of the data of the associated data set. For example, a data set may include a sequence of numerical values, such as results from a sequential experiment or business data, such as key performance indicators (KPIs), which may be represented by cylinders stacked on top of each other wherein the height and/or diameter of each cylinder may correspond to the respective numerical value. However, it is to be understood that stacked cylinders are described as one example only and other geometric primitives in other arrangements may also be used for the same or another data type.

According to another embodiment, the at least one graphic element is dynamically re-associated with the at least one data set based on the processing of the at least one data set. A graphic element may, for example, be associated with a first data set or a subset of the first data set, including components of the first data set, which may correspond to a current focus of the data analysis. A user may provide user input specifying a shift of the focus to a second data set or subset of the first and/or second data set, including components of the first and/or second data set. Based on the provided user input, the associated graphic elements may be re-associated, for example, with the second data set or the subset of the first and/or second data set, or respective components of the subset, representing the new focus of the data analysis. Furthermore, at least some other graphic elements may be re-associated with the remaining data sets, subsets, or components thereof. For example, graphic elements may be initially associated with a component of a subset of a data set and may be dynamically re-associated to other components of the subset of the data set responsive to the user input.

According to another embodiment, the processing component is configured to render the processed at least one data set by updating transformations of the at least one graphic element in the scene graph, determining a viewing perspective on the scene graph, responsive to the user input, and rendering the scene graph. The user input may, for example, indicate a desired translation or rotation of the whole scene, a plurality of data sets, a data set, subset or component thereof, or of graphic elements associated with the data set. The processing component may update the transformation matrix of one or more group nodes and/or one or more leaf nodes to reflect the desired translation and/or rotation of respective graphic elements. The scene graph may be traversed and the final scene may be rendered from the viewing perspective.

In a further embodiment, the processing component is further configured to adjust the viewing perspective, responsive to the user input, and to render the data sets based on the adjusted viewing perspective.

In yet another embodiment, the processing component is further configured to arrange the at least one graphic element on a rectangular grid. For example, a 4×4 grid, an 8×8 grid, a 16×16 grid, or an m×n grid, with m and n being integers, can be used. The graphic elements associated with each data set, subset, or components thereof can be stacked vertically at a respective cell of the grid, such that each cell of the grid may represent data related to a data set, subset, or component thereof. However, it is to be understood that other arrangements of graphic elements on cells of the grid can also be chosen based on the type and structure of the data. Each axis of the grid may correspond to a parameter of the data sets, such as time, location, type, and other parameters.

In a further embodiment, the system is coupled to one or more user devices, the input interface further configured to receive the user input from at least one of the one or more user devices and the output interface further configured to provide the rendered data to at least one of the one or more user devices. Preferably, the one or more user devices may comprise one or more of a mobile device, a computing device, and a presentation environment, and combinations thereof. For example, a plurality of users may provide user input via their respective mobile devices in order to influence processing of the data sets by the system, and a large-scale presentation environment may be used to present the final rendered data.

In yet another embodiment, the system hosts an online render service configured to stream the rendered output to at least one of the one or more user devices via the output interface. The online render service may be implemented as a module of the processing component or as a separate component and may, for example, be configured to receive the processed at least one data set from the processing component, associate the graphic elements with the individual data sets, render the scene graph, and generate a rendered output stream that may be provided to the respective user devices. It is to be understood that the online render service may also be configured for one of the aforementioned tasks or any subset thereof, and the remaining tasks may be performed by the processing component. Since the rendering is completed online by the system and final rendered output streams are directly provided by the online render service to the user devices, the user devices need not include any dedicated rendering hardware or software in order to present the rendered output. Rather, the user devices may be configured to receive and display streams on suitable output means. The online render service can provide audio streams, image/video streams, and/or streams for other modalities or combinations of modalities, such as audio, image/video, haptic feedback, force feedback, olfactory feedback, gustatory feedback, and combinations thereof. For example, the online render service may provide two streams, an image stream and an audio stream that are provided to the user device and output on a display and on speakers, respectively.

In yet another embodiment, the one or more user devices comprise input means and/or display means, said input means adapted to provide the user input and/or said display means adapted to display the rendered data. The input means may comprise one or more of a keyboard, a pointing device (such as a mouse, trackball, joystick, touchscreen, or touchpad), microphones, video cameras, and other sensors and trackers suitable to monitor and process input gestures of a user. For example, the video cameras may be configured to track facial expressions of the user and based on recognized facial expressions may generate corresponding user input data. Likewise, microphones may receive audio signals corresponding to spoken words, may recognize a command based on the audio signals, and generate user input data indicating the recognized command. The output means may comprise a projector, a display device, a stereoscopic display device, speakers, vibration devices, force feedback devices, and other output units suitable to represent rendered data in one or more modalities. Any combination of user devices including various input and output means may be connected to the system in order to provide user input and individually receive rendered data. For example, the system may be connected to a plurality of user devices and at least some of the connected user devices may be used as trackers to determine a transformation of a plurality of graphic elements associated with individual data sets and the rendered data may, for example, be provided to another user device dedicated to present the rendered data in one or more modalities.

In yet another embodiment, at least one of the one or more user devices includes a tracker, wherein the tracking data is provided as the user input to the processing component and used to configure the rendering of the processed at least one data set. The user device may include hardware capable of determining a position and orientation of one or more tracking sensors in space, which may be provided as the user input to the processing component and used to update a transformation matrix of nodes of the scene graph or of the viewing perspective.

In yet another embodiment, the processing component is configured to provide control data adapted to control a tangible virtual space, wherein the rendered data include at least visual 3D data displayed in the virtual space. Preferably, the virtual space is one of a virtual reality environment, an augmented reality environment, and a mixed reality environment. Virtual reality, as used throughout this description, refers to computer-simulated environments, which provide a realistic and interactive three-dimensional representation of a computer-generated virtual world or scene. Augmented reality, as used throughout this description, refers to environments, which provide an interactive representation of a physical, real-world environment whose elements are augmented by computer-generated or computer-simulated virtual elements, which are integrated into the real-world environment in a realistic fashion. For example, the virtual elements may be placed at a same position and with a same orientation as the elements of the real world, thereby superimposing and following the real elements. The virtual elements may also be simulated to behave according to physical rules in the real world. Mixed reality, as used throughout this description, refers to a combination of virtual reality concepts and augmented reality concepts, wherein virtual scenes are mixed with augmented scenes. Mixed reality refers to the merging of real and virtual worlds to produce new environments where real and virtual elements co-exist and interact in real time. The use of virtual reality, augmented reality, and mixed reality enables a realistic, intuitive and direct perception of large and complex data sets and enables deep insights into the structure of the data.

A tangible virtual space may require hardware to provide a realistic experience, including tracking hardware to track current positions of individual users in the environment, further input hardware to provide user input data enabling interaction with the presented virtual and/or real elements, and output hardware to provide a realistic representation of the computer-generated scene and/or a realistic overlay of the real scene, such as stereoscopic display hardware, tracking hardware, and/or spatial acoustics hardware. Preferably, the system may be connected to a plurality of user devices that may individually or conjointly provide the respective tracking means, input means, and output means in order to provide the tangible virtual space.

In yet another embodiment, the processing component is further configured to render a representation of one or more interactive elements into the rendered data and to receive user input related to an interaction with at least one of the interactive elements. The interactive elements may include one or more of a slider, a scrollbar, a button, a representation of a position and/or orientation of a pointing device, a highlighting element, such as a bounding box indicating graphic elements that can be selected, and other suitable interactive elements. A user may activate an interactive element with a suitable input device of a user device. The respective user input data may specify the interactive element and the selected graphic element, data set, subset or component thereof. For example, the user may interact with a slide bar to select different viewing perspectives. The processing component updates the viewing perspective on the scene graph responsive to the user input and provides updated rendered data in accordance with the chosen perspective.

In yet another embodiment, the processing component is further configured to dynamically update the data set and to process and interactively render the updated data sets. Based on the user input, the processing component may access the proxy component and request an update of one or more of the data sets. The proxy component may forward the request to the data sources and wait for the results, which are forwarded to the processing component.

Preferably, the processing component is further configured to process the at least one data set by filtering the at least one data set responsive to the user input. The user input may include indications of data sets that are to be included into or excluded from the data analysis. Based on these indications, the processing component may discard the respective data sets from further processing or may include the respective data sets into the processing. The indication may also be used for a request of updated data sets.

In yet another embodiment, the processing component is further configured to expand the data sets, responsive to the user input, including requesting new data from the one or more data sources for the expanded data sets. At least one of the users may, for example, indicate that a particular data set is to be expanded. For example, the data set may be originally represented by one graphic element only and the user may indicate that the data set is to be expanded. Based on the user input, the processing component may either associate new graphic elements with further components of the data set if the respective components have already been received by the processing component, or the processing component may trigger the proxy component to receive the further components related to the expanded data set. The processing component may thereafter associate further graphic elements with the components of the expanded data set in order to display the detailed data. Furthermore, the data sets may be arranged according to axes of a grid and each axis may represent a parameter of the data sets. By expanding the data sets, the parameter of at least one axis can be adjusted to the parameter of the components and the graphic elements representing the individual components may be distributed along this axis.

According to another embodiment, the processing component is further configured to select a data set, responsive to the user input, and to process and render the selected data set. The user may, for example, point to a particular data set using an input device of a user device and may indicate that the data set is to be selected.

In yet another embodiment, said rendering the selected data set includes moving the remaining data sets outside of a field of view and focusing on the selected data set. Initially, a plurality of data sets may be included in the rendered output and a user may select one of the rendered data sets. The processing component may identify the remaining data sets and apply an animation, which may move the graphic elements associated with the remaining data sets outside or to the periphery of a field of view. The remaining data sets may be any rendered data sets other than the selected data set. After moving the remaining data sets outside or to the periphery of the field of view, the respective graphic elements may be de-associated and deleted. In a next step, the selected data set may be expanded and represented with more details, as described in other embodiments.

In yet another embodiment, the processing component is further configured to aggregate the one or more data sets into a single data set, responsive to the user input. A user may select two or more data sets or respective graphic elements. Based on the user input, the processing component may combine the data or components of the selected data sets, de-associate at least some of the graphic elements and adjust the remaining data elements to the values of the remaining aggregated data set.

In yet another embodiment, the system further comprises a rendering engine coupled to the processing component and configured to receive the processed data sets from the processing component and to render the processed data sets. A rendering engine, as used throughout this description, is a software and/or hardware framework capable of receiving an abstract representation of a scene including graphic elements, acoustic elements, and elements of any other modality, as well as definitions of conditions in the scene, such as light conditions. The rendering engine is capable of processing the information and delivering a highly realistic representation of the scene, including a highly realistic graphical visualization. The rendering engine may utilize dedicated rendering hardware capable of computing a realistic appearance of the elements or individual objects taking into account surface characteristics, reflections, multiple light sources, ambient light, and other conditions. Preferably, the rendering engine is independent of any particular application, which may be executed independently on the processing component, and may process any requests from different applications for scenes to be rendered. The rendering engine may be implemented on a dedicated computing device coupled to the processing component or as a part of the processing component. The rendering engine may be the CryEngine available from Crytek GmbH, Frankfurt am Main, Germany. The rendering engine may be configured to provide a rendering quality that is comparable to the best-looking, animated, photorealistic graphics available for real-time rendering for any applications, such as games, business, television applications, and others.

According to another embodiment, the data sources include one or more databases. For example, the data sources may include SAP HANA, Oracle, SQL, and other databases. Preferably, more than one data source including one or more databases can be combined to provide the data sets. The system may connect via the proxy component, such as a proxy server, to the actual data sources including the databases. Through the interface of the proxy component, any standard or custom-made database can be attached without changing the actual application.

In yet another embodiment, the data sets represent data related to an enterprise or a company. For example, the data sets may correspond to business data or administrative data related to a company or an organizational entity, such as key performance indicators and others.

According to another aspect, a method for dynamic data analytics comprises the steps of sending, via an interface of a proxy component, a request for data to one or more data sources and receiving, via the interface, at least one data set from the one or more data sources. User input is received via an input interface. Responsive to the user input, the at least one data set is processed by a processing component and the processed at least one data set is rendered into rendered data by the processing component. The rendered data is provided via an input interface.

In one embodiment, the method comprises associating at least one data set with at least one graphic element arranged in a scene graph.

According to another embodiment, the method comprises dynamically re-associating the at least one graphic element with the at least one data set based on the processing of the at least one data set.

In yet another embodiment, said rendering the processed at least one data set includes updating transformations of the at least one graphic element in the scene graph, determining a viewing perspective on the scene graph, responsive to the user input, and rendering the scene graph.

According to a further embodiment, the method further comprises adjusting the viewing perspective responsive to the user input and rendering the data sets based on the adjusted viewing perspective.

In one embodiment, the at least one graphic element is arranged on a rectangular grid.

In a further embodiment, the at least one data set is processed by filtering the at least one data set responsive to the user input.

According to another embodiment, the method comprises hosting an online render service, and streaming the rendered output to at least one of the one or more user devices via the output interface.

According to yet another embodiment, the method comprises rendering a representation of one or more interactive elements into the rendered data and receiving input data related to an interaction with at least one of the interactive elements.

In one embodiment, the method comprises dynamically updating the data sets and processing and interactively rendering the updated data sets.

According to another embodiment, the method comprises expanding the data sets, responsive to the user input, including requesting new data from the one or more data sources for the expanded data sets.

According to a further embodiment, the method comprises selecting a data set, responsive to the user input, and processing and rendering the selected data set.

In an embodiment, said rendering the selected data set includes moving the remaining data sets outside of a field of view and focusing on the selected data set.

In a further embodiment, the method comprises aggregating the one or more data sets into a single data set, responsive to the user input.

In another embodiment, the method comprises receiving the processed data sets from the processing component by a rendering engine and rendering the processed data sets by the rendering engine.

According to yet another aspect, a computer-readable medium is provided, said computer-readable medium having instructions stored thereon, wherein said instructions, in response to execution by a computing device, cause said computing device to automatically perform a method according to embodiments of the present disclosure. In particular, the automatically performed method for dynamic data analytics, may comprise the steps of sending, via an interface of a proxy component, a request for data to one or more data sources and receiving, via the interface, at least one data set from the one or more data sources, receiving user input via an input interface, responsive to the user input, processing the at least one data set by a processing component and rendering the processed at least one data set into rendered data by the processing component, and providing the rendered data via an output interface.

The disclosure provides a system and a method for dynamic data analysis which allows for an interactive presentation and exploration of large and complex data sets. The ability to interact with the large and complex data set leads to an intuitive use, understanding and analysis of the data sets, and increases the effectiveness of understanding of the data sets, enabling an in-depth analysis as well as ad hoc searches in the data sets.

The data and data sets may describe abstract representations of experimental results and results of physical and/or chemical simulations, as well as administrative data related to business and administrative entities. The data and the visualization may be further attributed to data spaces, conditions and factors such as, but not limited to, monthly production and revenue, supply chain values, etc. Dynamic rendering and visualization of the abstract representations in tangible 3D spaces fits the human perception much better; as relationship between data is easier to understand, insight into the data is faster to grasp, and results of the analysis can be retrieved faster.

### DESCRIPTION OF THE DRAWINGS

The specific features, aspects and advantages of the present disclosure will be better understood with regard to the following description and accompanying drawings where:

FIG. 1 shows a flow chart of a method according to one embodiment of the present disclosure;

FIG. 2 shows a schematic diagram of a system according to another embodiment of the present disclosure; and

FIGS. 3-11 show schematic views on rendered output and interactive elements according to various embodiments of the present disclosure.

### DETAILED DESCRIPTION

In the following description, reference is made to drawings which show by way of illustration various embodiments. Also, various embodiments will be described below by referring to several examples. It is to be understood that the embodiments may include changes in design and structure without departing from the scope of the claimed subject matter.

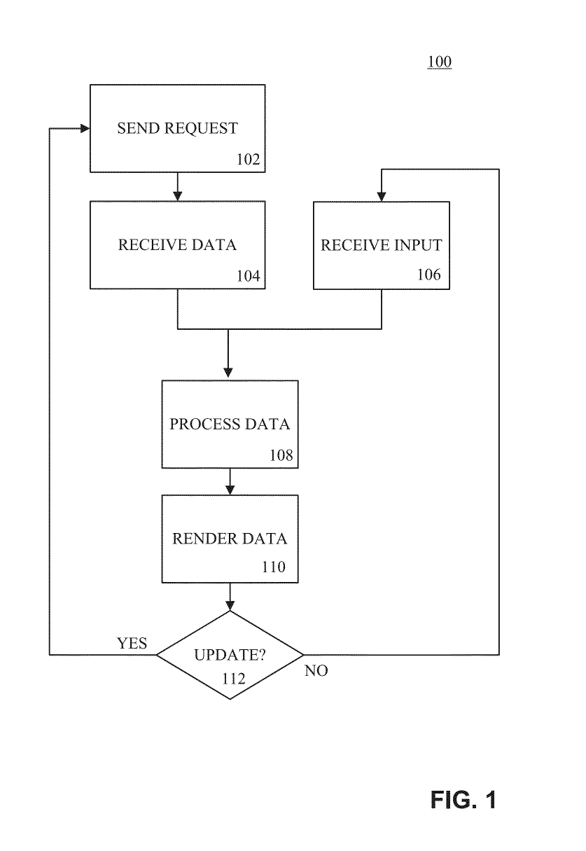

FIG. 1 shows a flow chart of a method according to one embodiment of the present disclosure. The method 100 for dynamic data analytics may comprise sending, via an interface of the proxy component, a request for data to one or more data sources in step 102, and receiving, via the interface, at least one data set from the one or more data sources in step 104. Furthermore, user input may be continuously received in step 106.

The received data sets and the user input are combined in step 108 where, responsive to the user input, the received data sets may be processed. In step 110, the processed at least one data set may be rendered into rendered data.

In step 112, a determination is made whether an update for data is required. If an update is required, a new request for updated data is formulated and the method continues with step 102. If no update is required, the method continues with receiving further user input in step 106.

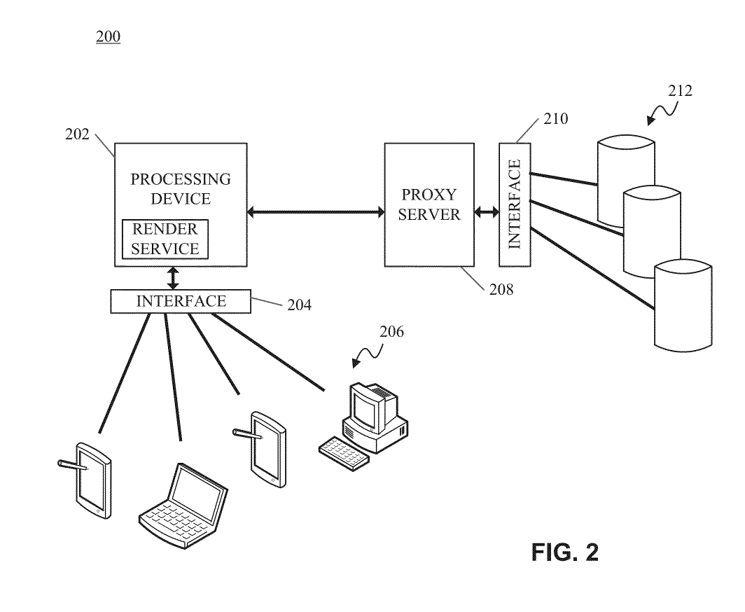

FIG. 2 shows a schematic diagram of a system according to one embodiment of the present disclosure. The system 200 includes a processing component 202, which is coupled to an I/O interface 204, including an input interface configured to receive user input and an output interface configured to provide rendered data. The processing component 202 may communicate via the I/O interface 204 with a plurality of user devices 206, such as mobile phones, standard personal computers, and large-scale presentation environments. The system 200 can be launched or implemented on one or more standard computing devices, such as personal computer desktop machines or one or more servers, or may be used as a render service. The render service can then be accessed by mobile devices, such as Android, iOS, or Windows mobile phones and tablets to provide the same experience on mobile devices as on stationary computers.

The processing component 202 may be coupled to a proxy component 208 including an interface 210. The proxy component 208 may be configured to send, via the interface 210, requests for data to one or more data sources 212 and receive, via the interface 210, at least one data set from the one or more data sources 212 in response to the request. The at least one data set may be further provided to the processing component 202. Responsive to any user input received via the I/O interface 204, the processing device 202 may process the at least one data set and render the processed at least one data set into the rendered data provided via the I/O interface 204 to the user devices 206. The processing device 202 may also host a render service, which is provided with the processed data sets and renders the data sets.

The claimed subject matter can be implemented using object-oriented programming techniques. For example, each component or interface of the system and each processing step of the method according to embodiments of the present disclosure can be an object of a software module. Object-oriented programming utilizes units of software called “objects,” which encapsulate both data and functions. Accordingly, objects according to object-oriented programming represent software entities comprising data structures and operations on the data. This structure enables objects to model any real-world entity in terms of its characteristics, represented by its data elements, and its behavior, represented by its functions. In this way, objects can model real things like users and computers, and abstract concepts like mathematical functions or geometrical computations.

As used in this description, the terms “component,” “interface,” and “system” are intended to refer to a computer-related entity, either hardware, firmware, a combination of hardware and software, or software in execution. For example, a component can be, but is not limited to a process running on a processor, a processor, a storage device, an object, an executable, a thread, a program, and/or a computer. By way of illustration, both an application running on a server and the server can be a component. One or more components can reside within a process and/or thread of execution, and a component can be localized on one computer and/or distributed between two or more computers.

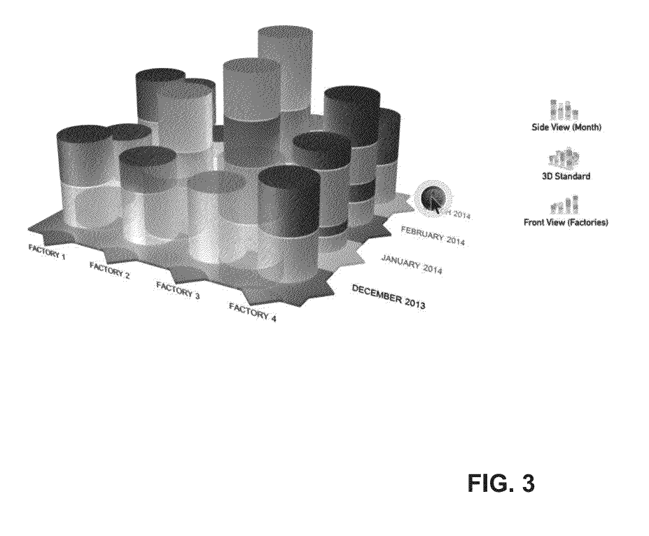

FIG. 3 shows a standard view on rendered data of the data sets according to one embodiment. The displayed sample data sets may include data of four factories and the accumulated production capacities, which may be listed for the months December to March. The data sets or their subsets and components thereof may be represented by cylinders that may be stacked on top of each other and arranged on a 4×4 grid, wherein the rows of the grid represent the respective time range, e.g., months in this example, and the columns represent the individual entities, e.g., factories in this example. Accordingly, each cell may represent the product data of a factory in one month. The output may be presented on an output device, such as on a screen or display of a user device 206 as shown in FIG. 2. The user may utilize any input means of the user device to scroll from top to bottom or vice versa in order to scroll through the rows of the grid representing the months. Furthermore, the input means may also be used to scroll through the factories by scrolling the columns from left to right (and vice versa). The user input related to the scrolling is provided to the processing component, such as the processing component 202 of FIG. 2, and used to update, process, and render the respective data. Such user input may include, for example, swipe gestures or other suitable input from a touchscreen. FIG. 3 also shows interactive elements enabling an adaptation of the viewing perspective, as will be described further below.

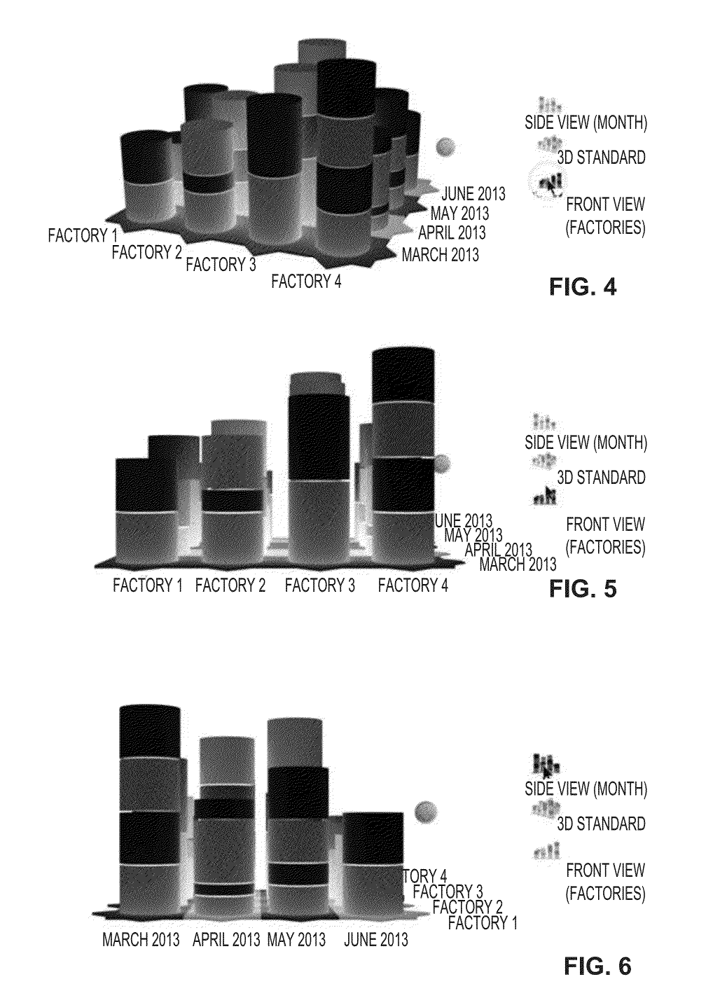

FIGS. 4 to 6 show different views on rendered data according to embodiments of the present disclosure, illustrating a switch to different perspectives using interactive elements. In FIG. 4, the user can click on a shortcut provided by the interactive element to switch to a predetermined view, such as a front view or a side view. The user input specifying the selected perspective may be provided to a processing component, such as the processing component 202 of FIG. 2, which may be used to update the transformation matrix and the viewing perspective in a scene graph, which is thereafter used to render the selected view. FIG. 5 shows a switching to a front view, for example, by selecting a respective interactive element. The front view may show aggregated data of the columns, e.g., data related to the factories, ignoring a detailed view of the rows, representing monthly data, for example. Instead, the data may be added according to a criteria of the rows, for example, per year, per quarter, etc. FIG. 6 shows a switching to a different perspective, such as a side view, which may, for example, be achieved by selecting another interactive element. The side view may focus on the data of the rows, such as monthly values, and may ignore detailed column data, such as per-factory information.

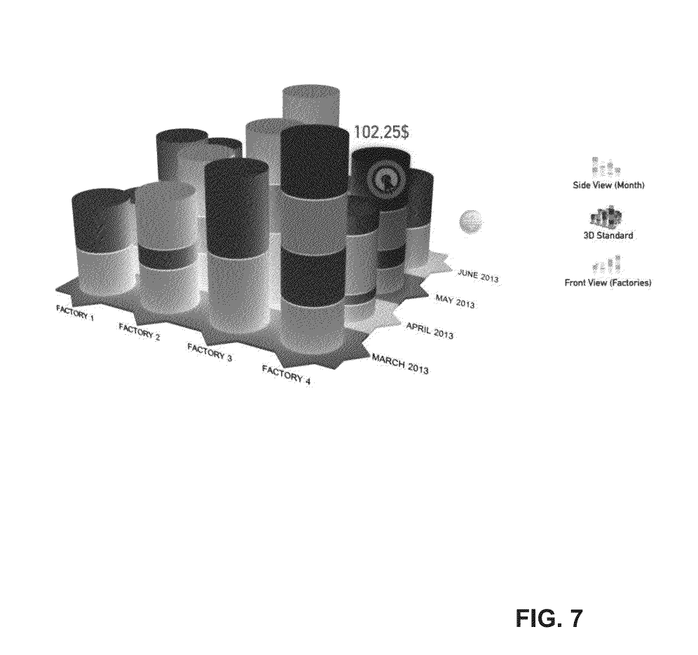

FIG. 7 shows another embodiment of the present disclosure illustrating a dive into the data. The data, including a sum or other numerical value associated with a graphic element, may be rendered in response to a user clicking on or selecting a particular graphic representation of the data set. The interaction may open up more detailed information behind the graphic element or data item. Usually, most data displayed by a graphic element may be a summary of more “low-level” data of the data set. For example, each data set may be arranged on a rectangular grid, wherein the axes of the grid define parameters characterizing the data sets, such as time and location. Each data set may include components referring to further sub-entities, such as individual products produced in the time and location of the data set, such as products A, B, C, and D. The value of each component of the data set may be represented by a cylinder and the cylinders may be stacked on top of each other to form an enlarged cylinder representing the whole data set.

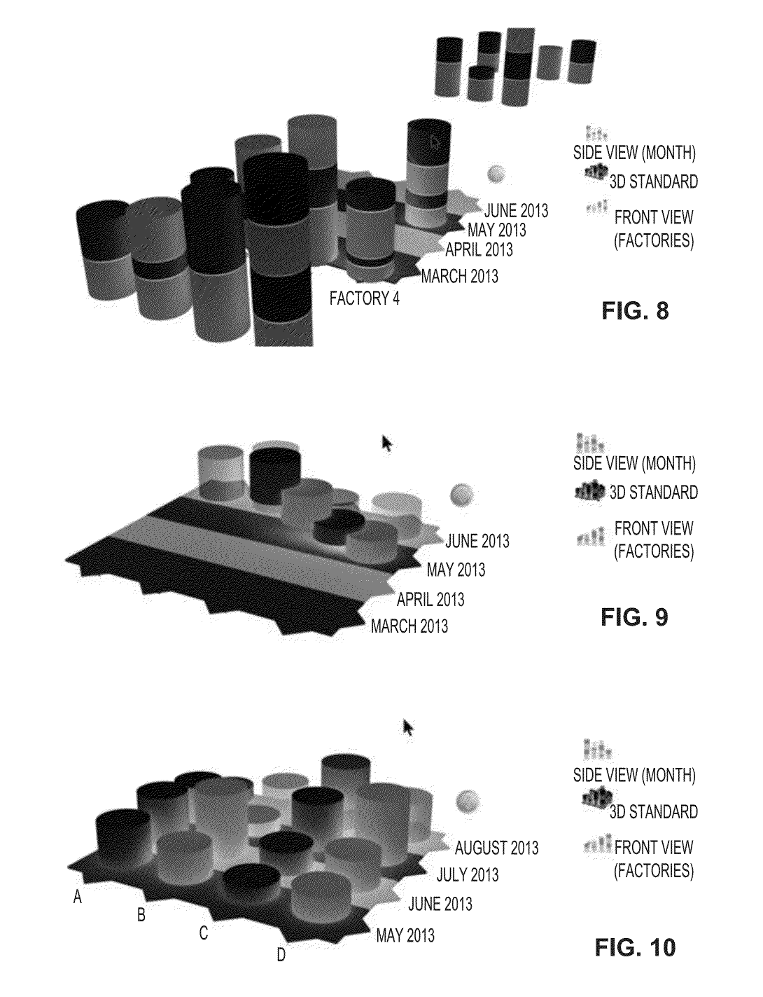

By focusing on one of the data sets, for example, by selecting the respective enlarged cylinder, such as the data set representing the products of factory 4 produced in March, the representations of the remaining data sets may be removed, as shown in FIG. 8. The interaction may also trigger other processing, such as an animated dive into the data. For example, the user interaction with the graphic element may start an animation, wherein the selected graphic element is preserved and the other existing graphic elements may be moved away, giving room for the selected dive-in data set.

As shown in FIG. 9, the removed graphic elements may be deleted and the data set that the user wants to look into may be laid down using free space. In particular, the components of the focused data set may be distributed on the free grid cells in one direction, either in the column or row direction, and the axis of the column or row may be assigned to a further parameter corresponding to the components, such as a product type. Hence, in the example in FIG. 9, the product data of one factory produced in one month is shown representing the different products A, B, C, and D next to each other, instead of stacked on top of each other.

As shown in FIG. 10, the remaining rows or columns may be populated with updated data of the other data sets according to the further parameter as defined by the components of the focused data set. In the example shown in FIG. 10, the data for the individual expanded products A, B, C, and D produced in factory 4 will be shown for the other months. Hence, the animation may update the remaining space, e.g., the months preceding and following the selected month, with the detailed data, such as the product data of the factory in the other months and the user may analyze in detail the four different products of the focused factory.

Even though in the examples shown in FIGS. 7 to 10, a selection and dive-in into different products of a factory has been executed, the present disclosure enables different dive-ins, which can be executed in a similar fashion, such as analyzing only one product over all factories, analyzing one month in detail, etc.

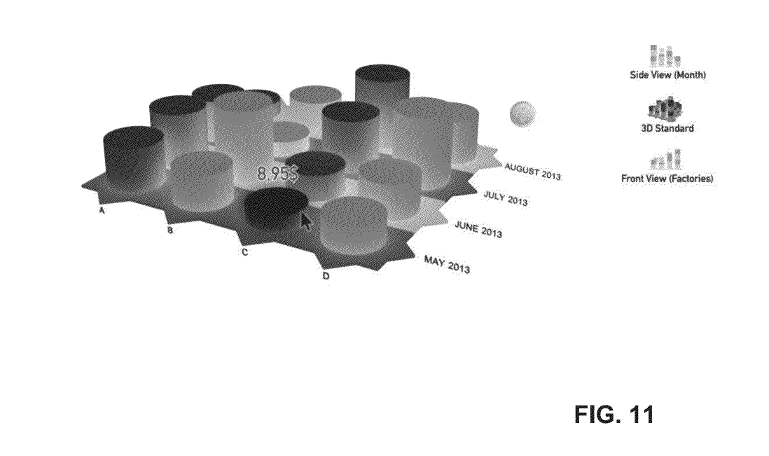

FIG. 11 shows a further detailed view on the rendered output, wherein in addition to the displayed graphic elements representing the data sets, such as cylinders, more information can be displayed by hovering over the respective graphical representation. As shown in FIG. 11, more data may be displayed over time.

Some portions of the detailed description have been presented in terms of algorithms and/or symbolic representations of operations on data bits within a computer memory. These algorithmic descriptions and/or representations are the means employed by those skilled in the art to most effectively describe the substance of their work to others equally skilled. An algorithm is here, generally, conceived to be a self-consistent sequence of acts leading to a desired result. The acts are those requiring physical manipulations of physical quantities, such as electrical and/or magnetic signals. Conveniently, these physical quantities and signals are referred to as bits, values, elements, symbols, characters, terms, numbers, or the like. Unless specifically stated otherwise, it is appreciated that throughout the disclosure, discussions utilizing terms such as processing, computing, calculating, determining, and/or displaying, and the like, refer to the actions and processes of computer systems, and/or similar consumer and/or industrial electronic devices and/or machines, that manipulate and/or transform data represented as physical quantities within the computer's and/or machine's registers and memories into other data similarly represented as physical quantities within the machine and/or computer system memories or registers, or other such information storage, transmission, and/or display devices.

The inventive system provides an interactive and flexible presentation of large and complex data sets. The approach allows for delivering visual representations of a very high rendering quality, which does not require dedicated processing and rendering hardware to enable the rendering and which is capable of rendering highly complex and voluminous data sets in an interactive and dynamic and flexible fashion.

While some embodiments have been described in detail, it is to be understood that the aspect of the disclosure can take many forms. In particular, the claimed subject matter may be practiced or implemented differently from the examples described and the described features and characteristics may be practiced or implemented in any combination. The embodiments shown herein are intended to illustrate rather than to limit the invention as defined by the claims.

The embodiments of the invention in which an exclusive property or privilege is claimed are defined as follows:

1. A system for dynamic data analytics, comprising:
a proxy component including an interface, said proxy component configured to send, via the interface, a request for data to one or more data sources and to receive, via the interface, at least one data set from the one or more data sources;
an input interface configured to receive user input;
a processing component coupled to the proxy component and the input interface, said processing component configured to receive the at least one data set from the proxy component and, responsive to the user input, to process the at least one data set and to render the processed at least one data set into rendered data; and
an output interface configured to provide the rendered data.

2. The system according to claim 1, wherein the at least one data set is associated with at least one graphic element arranged in a scene graph.

3. The system according to claim 2, wherein the at least one graphic element is dynamically re-associated with the at least one data set based on the processing of the at least one data set.

4. The system according to claim 2, wherein the processing component is configured to render the processed at least one data set by updating transformations of the at least one graphic element in the scene graph, determining a viewing perspective on the scene graph responsive to the user input, and rendering the scene graph.

5. The system according to claim 4, wherein the processing component is further configured to adjust the viewing perspective, responsive to the user input, and to render the data sets based on the adjusted viewing perspective.

6. The system according to claim 1, wherein the processing component is further configured to arrange the at least one graphic element on a rectangular grid.

7. The system according to claim 1, wherein the system is coupled to one or more user devices, the input interface further configured to receive the user input from at least one of the one or more user devices and the output interface further configured to provide the rendered data to at least one of the one or more user devices.

8. The system according to claim 7, wherein the system is configured to host an online render service configured to stream the rendered output to at least one of the one or more user devices via the output interface.

9. The system according to claim 7, wherein the one or more user devices comprise input means and/or display means, said input means configured to provide the user input and/or said display means configured to display the rendered data.

10. The system according to claim 7, wherein at least one of the one or more user devices includes a tracker, and wherein tracking data is provided as the user input to the processing component and used to configure the rendering of the processed at least one data set.

11. The system according to claim 1, wherein the processing component is configured to provide control data configured to control a tangible virtual space, wherein the rendered data include at least visual 3D data displayed in the virtual space.

12. The system according to claim 1, wherein the processing component is further configured to render a representation of one or more interactive elements into the rendered data and to receive user input related to an interaction with at least one of the interactive elements.

13. The system according to claim 1, wherein the processing component is further configured to dynamically update the data sets and to process and interactively render the updated data sets.

14. The system according to claim 1, wherein the processing component is further configured to expand the data sets, responsive to the user input, including requesting new data from the one or more data sources for the expanded data sets.

15. The system according to claim 1, wherein the processing component is further configured to select a data set, responsive to the user input, and to process and render the selected data set, wherein said rendering the selected data set includes moving the remaining data sets outside of a field of view and focusing on the selected data set.

16. The system according to claim 1, wherein the processing component is further configured to aggregate the one or more data sets into a single data set, responsive to the user input.

17. The system according to claim 1, further comprising a rendering engine coupled to the processing component and configured to receive the processed data sets from the processing component and to render the processed data sets.

18. A method for dynamic data analytics, comprising the steps of:
sending, via an interface of a proxy component, a request for data to one or more data sources;
receiving, via the interface, at least one data set from the one or more data sources;
receiving user input via an input interface;
responsive to the user input, processing the at least one data set by a processing component;
rendering the processed at least one data set into rendered data by the processing component; and
providing the rendered data via an output interface.

19. The method according to claim 18, further comprising:
associating at least one graphic element with the at least one data set, wherein the at least one graphic element is arranged in a scene graph; and
dynamically re-associating the at least one graphic element with the at least one data set based on the processing of the at least one data set.

20. The method according to claim 19, further comprising:
rendering the processed at least one data set by updating transformations of the at least one graphic element in the scene graph;
determining a viewing perspective on the scene graph, responsive to the user input; and
rendering the scene graph.

21. A computer-readable medium having instructions stored thereon, wherein said instructions, in response to execution by a computing device, cause said computing device to automatically perform a method for dynamic data analysis, including:
sending, via an interface of a proxy component, a request for data to one or more data sources;
receiving, via the interface, at least one data set from the one or more data sources;
receiving user input via an input interface;
responsive to the user input, processing the at least one data set by a processing component;
rendering the processed at least one data set into rendered data by the processing component; and
providing the rendered data via an output interface.
